(19) United States
(12) Patent Application Publication
(10) Pub. No.: US 2008/0145891 A1
(43) Pub. Date: Jun. 19, 2008

(54) Apparatus and method for processing histological specimens

(76) Inventor: Brian Christopher Burton, Simpsonville, SC (US)

Correspondence Address: J. BENNETT MULLINAX, LLC, P. O. BOX 26029, GREENVILLE, SC, 29616-1029, US

(21) Appl. No.: 11/639,740

(22) Filed: Dec. 15, 2006

(51) Int. Cl. G01N 1/30; G01N 1/31

(52) U.S. Cl. 435/40.51; 435/283.1; 435/309.1

(57) ABSTRACT

Apparatuses for processing histological specimens are provided. One apparatus includes a cap that is placed on a vessel used for holding stains. The cap has a door through which a microscope slide and specimen can be inserted in order to apply stain thereon. Removal of the slide causes the door to move back into the closed position to prevent loss of stain in the vessel. An apparatus for heating the microscope slide and specimen is also provided in which the slide is received by a port of the apparatus. Heat is generated by a heater of the apparatus to affix the specimen onto the slide. An associated method is also provided.

### FIELD OF THE INVENTION

The present invention relates generally to an apparatus and method for use in processing histological specimens. More particularly, the present application involves a stain jar cap and a heater for use in more quickly and efficiently preparing a histological specimen for study. An associated method is also provided.

### BACKGROUND

Histology is a branch of science that deals with the examination through a microscope of minute structures such as plant and animal tissue. Microscopic examination is essential in diagnosing certain diseases such as cancer or a bacterial infection. Current testing equipment and procedures are known for examining an agent, such as bacteria, under a microscope for purposes of evaluation.

A specimen for evaluation can be obtained by swabbing the throat or ears of a person or animal. A microscope slide can then be cleaned in order to ensure the specimen will spread out evenly across its surface. If the specimen is solid, a small amount of purified water can be placed on the slide into which the specimen can then be placed and spread. If the specimen is liquid, it can be placed directly onto the slide and spread over a small area. Next, the slide and specimen are heated in order to fix the specimen to the slide. The slide and specimen are lightly passed through an open flame in order to dry out the specimen so that it will adhere to the slide. As a general matter, the specimen and slide are passed through the open flame to be heated but not overheated so the slide is still comfortable to hold by the user. This step requires the provision of an open flame that can cause accidents such as burning of the clothing or hands of the user. Further, heating of the specimen in this manner is not a controlled heating but instead varies from procedure to procedure due to the way in which individuals move the slide over the flame on different occasions.

Bacteria are almost transparent when viewed and it is thus necessary to stain the bacteria with one or more pigments in order to provide sufficient contrast to the bacteria for viewing purposes. Known stains used in histological procedures include hematoxylin, eosin, cytoplasm and methylene blue. One or more drops of stain can be applied with an eye dropper to the specimen after it is heated and affixed to the slide. Excess stain can be rinsed off of the specimen with water and the stained specimen can be blotted dry with a lint free towel.

Other staining procedures call for the specimen and slide to be immersed in the stain. Here, stain is stored inside of a vessel such as a jar. The user removes the cap of the jar and places the slide into the liquid stain therein. Although this method is effective in applying stain to the specimen, it suffers from a few disadvantages. First, this procedure is messy in that since the slide is completely immersed into a jar of stain, the stain will drip off onto equipment or other items or surfaces in the vicinity. Additionally, the user may forget to reattach the lid of the jar after opening the jar and dipping the slide therein. Forgetting to reattach the lid may be a common occurrence in a laboratory environment in which multiple steps are performed one after the other. Further, one may forget to reattach the lid after applying stain to the specimen because the user is focused on quickly taking the specimen to the microscope for examination to avoid dripping the stain. Stain inside of a jar without an attached lid may be lost through spills or evaporation.

After the specimen is stained, the slide is transported to a microscope and the specimen is covered with a cover glass. A region of the specimen that is not excessively stained is usually identified and then examined with different objectives of the microscope to ascertain information about the bacteria present. Stain spilled from the staining step could find its way onto one or more of the objectives or other portions of the microscope to hinder viewing. Although current procedures and equipment are in place for examining a specimen, there remains room for variation and improvement within the art.

### SUMMARY

Various features and advantages of the invention will be set forth in part in the following description, or may be obvious from the description, or may be learned from practice of the invention.

One aspect of the present invention provides for a cap for use with a vessel for storage of a stain. The cap includes an end that defines an aperture therethrough. The aperture is sized to allow at least a portion of a microscope slide to be positioned therethrough. A door is present and is capable of changing positions with respect to the end. The door is capable of being positioned between a closed position to limit access through the aperture of the end and an open position to allow access through the aperture of the end.

Another aspect of the present invention provides for a cap as immediately discussed in which the door pivots with respect to the end.

A further aspect of the present invention resides in a cap as discussed above that further includes a spring that engages the door. The spring urges the door to the closed position.

Another aspect of the present invention is provided in a cap as discussed above that further includes a slide guide attached to an upper surface of the end. The slide guide has a pair of guide members positioned on opposite ends of the aperture of the end. The guide members each define a slide groove for receiving a microscope slide. The slide grooves extend at an angle to the upper surface of the end so that the slide grooves do not extend at a right angle to the upper surface of the end.

A further aspect of the present invention exists in a cap as discussed above in which the end and the door are made of polypropylene.

An additional aspect of the present invention is provided in an apparatus for use in heating a microscope slide. The apparatus includes a frame and a port that is carried by the frame. The port is configured for receiving a microscope slide. A heater is also included and is carried by the frame. The heater is configured for generating heat for use in heating a microscope slide when received by the port.

Another aspect of the present invention exists in an apparatus as immediately discussed in which the frame has a plurality of walls that define an interior. Also, the heater is located in the interior of the frame.

A further aspect of the present invention is found in an apparatus as immediately discussed that further includes a heat reflective surface located in the interior of the frame. The heat reflective surface is configured for reflecting heat onto a microscope slide when received by the port.

An additional aspect of the present invention resides in an apparatus as mentioned above in which the port defines a microscope slide aperture sized to allow a microscope slide to pass therethrough. Also, the port has a pair of ridges with an opening defined therebetween. The ridges are configured for receiving a microscope slide to hold the microscope slide during heating.

Another aspect of the present invention is provided in an apparatus as discussed above that has an on/off button for use in turning on the heater and turning off the heater. A timer is present for use in allowing the heater to remain on for a selected amount of time and then for turning off the heater after passage of the selected amount of time. Also, an indicating lamp is present for use in indicating when the heater is on.

The present invention also provides for a method of preparing a specimen for examination with a microscope. The method involves placing a specimen for examination onto a microscope slide. The specimen and slide are positioned to be received by a port of an apparatus that has an electric heater. The specimen and slide are heated with the electric heater of the apparatus to adhere the specimen to the microscope slide. The specimen and slide are removed from the port of the apparatus. At least a portion of the specimen and slide are inserted through a door of a vessel containing a stain into the interior of the vessel so that at least a portion of the specimen is stained by a stain contained in the vessel. The stained specimen and microscope slide are removed from the interior of the vessel.

Another aspect of the present invention is provided in a method as immediately discussed in which the inserting step involves moving at least a portion of the specimen and the microscope slide through a pair of slide grooves. The side grooves are defined by a pair of guide members positioned on opposite ends of an aperture defined in an end of a cap of the vessel. The door of the vessel is spring loaded to be urged into the closed position. Also, the inserting step involves urging the specimen and the microscope slide against the door to overcome the spring force of the door and push the specimen and the microscope slide into the interior of the vessel.

In accordance with another exemplary embodiment of the present invention, a method as discussed above is provided in which the positioning step involves inserting at least a portion of the specimen and the microscope slide through a microscope slide aperture. The microscope slide aperture is defined by the port. Also, the specimen and the microscope slide are located onto a pair of ridges of the port that are separated by an opening therebetween.

These and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a perspective view of a tray with three vessels that store stain and have a cap with a door for insertion of a microscope slide in accordance with one exemplary embodiment of the present invention.

FIG. 2 is a top view of a cap of FIG. 1 in the closed position.

FIG. 3 is a bottom view of a cap of FIG. 1 in the closed position.

FIG. 4 is a side view of a vessel and cap of FIG. 1 with a microscope slide inserted therein for purposes of staining a specimen on the microscope slide.

FIG. 5 is a perspective view of an apparatus for use in heating a microscope slide and specimen in accordance with one exemplary embodiment of the present invention.

FIG. 6 is a disassembled perspective view of the apparatus of FIG. 5.

FIG. 7 is a side view of the apparatus of FIG. 6 with a section of a wall of the frame removed for clarity.

FIG. 8 is a section view taken along line 8-8 of FIG. 6.

FIG. 9 is a top view of the apparatus of FIG. 6.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for apparatuses and methods for preparing a specimen 72 for study with a microscope. The apparatuses and methods discussed achieve a more efficient mechanism to heat a microscope slide 20 to affix a specimen 72 thereon, and a more efficient mechanism to stain the specimen 72 for study.

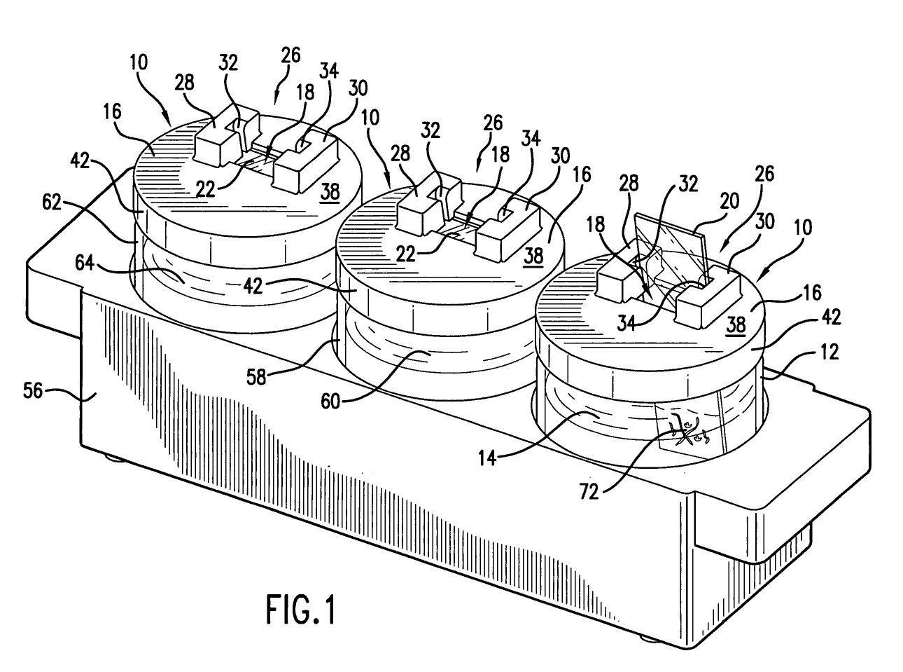

An apparatus provided in accordance with one exemplary embodiment of the present invention is shown in FIG. 1. Here, a vessel holder 56 is provided for holding a series of vessels 12, 58 and 62 that each contain stains 14, 60 and 64 that are used to stain a specimen 72 on a microscope slide 20 to aid in viewing under a microscope. The vessel holder 56 has a series of cavities into which the vessels 12, 58 and 62 are received. The vessel holder 56 also has a pair of arms extending therefrom on either end that can be used to hold the vessel holder 56 by a user during transport or to hook or otherwise hold the vessel holder 56 onto a structure for storage of the vessels 12, 58 and 62. Although shown as being a single piece component, the vessel holder 56 can be made of multiple components in accordance with other exemplary embodiments of the present invention.

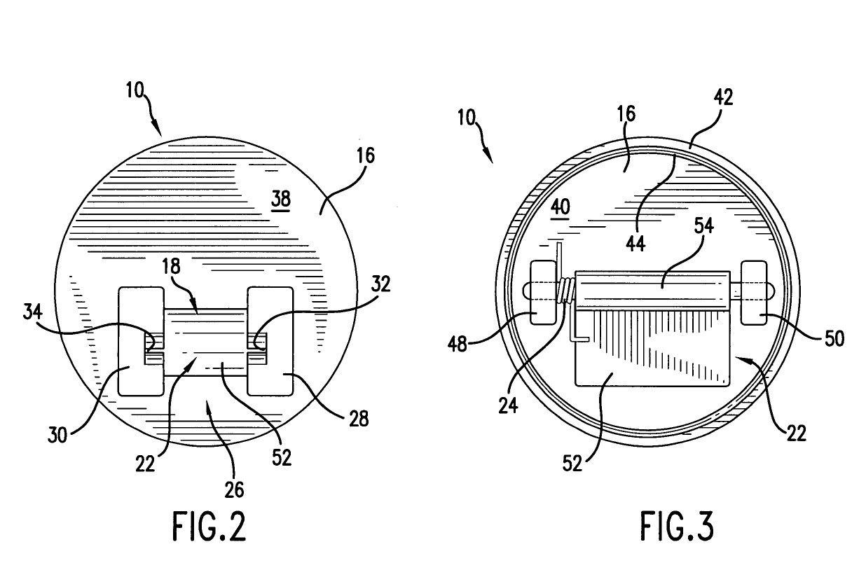

The vessel 12 is made of transparent glass and is capable of holding a stain 14 therein for use in staining the specimen 72. The vessel 12 can be made of other types of materials such as steel, plastic or aluminum in other embodiments. A cap 10 is located on an end of the vessel 12 in order to prevent stain 14 from spilling or evaporating therefrom. The cap 10 can be more clearly seen with reference to FIGS. 2 and 3 of the drawings. The cap 10 has a lip 42 extending from a lower surface 40 of an end 16. The lip 42 has threading 44 thereon that is configured to engage threading 46 of the vessel 12. In this manner, stain 14 can be poured into vessel 12 and the cap 10 can be screwed and secured onto vessel 12 through engagement of threading 44 and 46. Although described as being releasably attachable through the use of threading 44 and 46, cap 10 can be snap fit onto vessel 12 or connected through mechanical fasteners in accordance with other exemplary embodiments. Further, cap 10 can be integrally formed with vessel 12 in yet other embodiments of the present invention.

Cap 10 has an end 16 that defines an aperture 18 therethrough. A door 22 is present and is shown in FIGS. 2 and 3 in the closed position. Here, a flap 52 of door 22 is urged against the lower surface 40 of end 16 to prevent access through aperture 18. In this manner, should the vessel 12 be knocked or pushed over, stain 14 inside vessel 12 will be contained therein and prevented from escaping. The door 22 can be strongly urged against the lower surface 40 to create a seal tight enough to prevent stain 14 from escaping through aperture 18. Alternatively, door 22 may be urged with less force against lower surface 40 so that aperture 18 is not completely sealed but will allow stain 14 to slowly leak therefrom should vessel 12 be tipped over. In this instance, stain 14 will still be somewhat contained within vessel 12 and only minimal, if any, leaking from vessel 12 will occur.

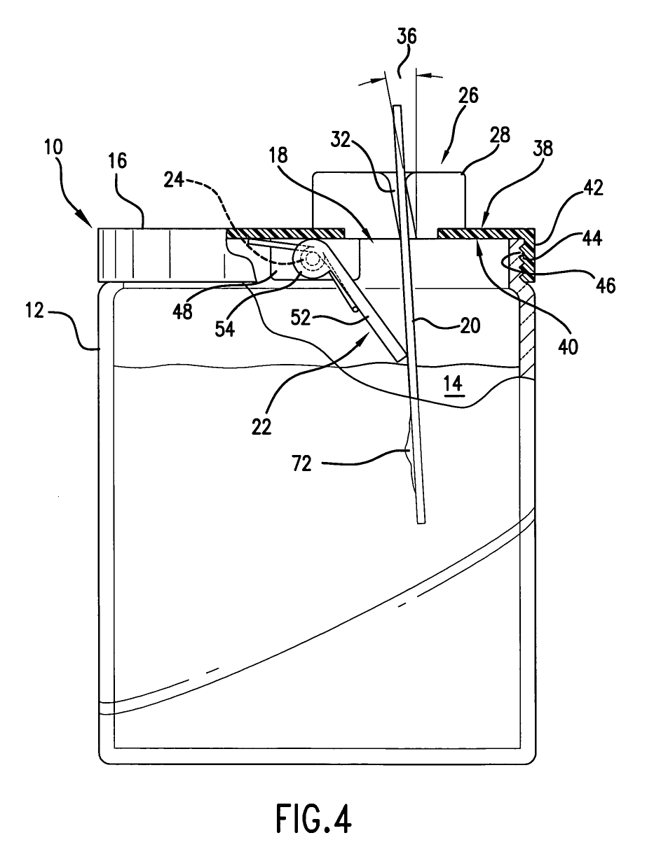

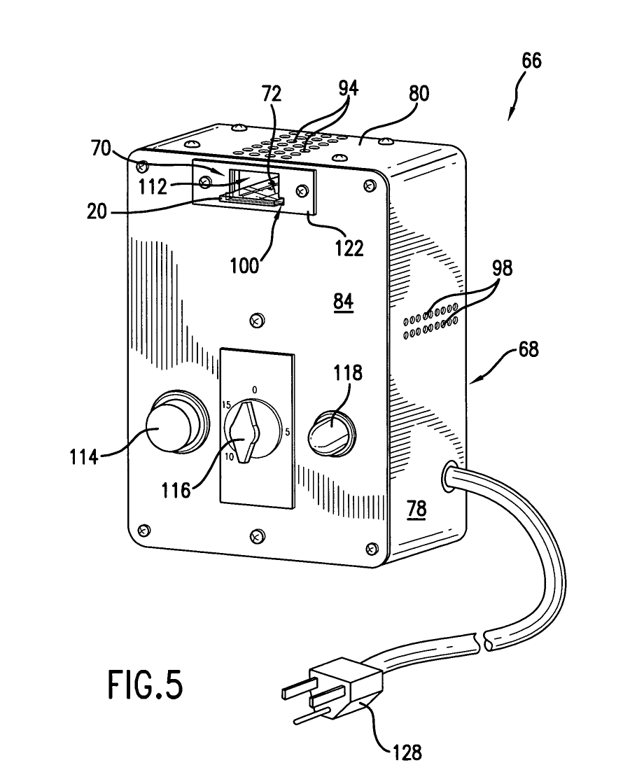

As stated, the vessel 12 is used to stain the specimen 72 on the microscope slide 20 to allow the specimen 72 to be better viewed under a microscope. FIG. 1 shows the microscope slide 20 with specimen 72 inserted through door 22 of cap 10 and into the vessel 12 to have stain 14 applied thereon. The user can insert any desired portion of microscope slide 20 into vessel 12 to have stain 14 applied thereto. Insertion of the microscope slide 20 into vessel 12 is shown in greater detail in FIG. 4. The cap 10 includes a slide guide 26 on an upper surface 38 of end 16. The slide guide 26 has guide members 28 and 30 positioned on opposite ends of the aperture 18. Guide member 28 defines a slide groove 32 and guide member 30 defines a slide groove 34. The microscope slide 20 is inserted into slide grooves 32 and 34 and urged against door 22 with a sufficient force to push open door 22 and insert microscope slide 20 into the interior of vessel 12 to apply stain 14 to specimen 72. Slide grooves 32 and 34 are each oriented at an angle 36 to the upper surface 38 of end 16 so that the slide grooves 32 and 34 are not perpendicular to the upper surface 38. Angle 36 may be 5° in accordance with certain exemplary embodiments of the present invention. In accordance with other exemplary embodiments, angle 36 is from 2° to 15°. Angle 36 is present in order to more easily open door 22 as the angle of force applied by pushing microscope slide 20 against door 22 acts to more easily open door 22 and keep microscope slide 20 in place when inserted into vessel 12. Although described as being oriented at an angle 36 to the upper surface 38, slide grooves 32 and 34 may be perpendicular to upper surface 38 in other exemplary embodiments. As such, angle 36 in these instances can be 0°. It is to be understood that the slide grooves 32 and 34 may be oriented at any angle 36 to upper surface 38 in other embodiments.

The mechanism responsible for urging door 22 to the closed position is shown in greater detail in FIG. 3. Here, a pair of brackets 48 and 50 extend from lower surface 40 of end 16. Brackets 48 and 50 are spaced an adequate distance from lip 42 in order to allow clearance for an upper end of vessel 12 for attachment of cap 10 to vessel 12 through threading 44 and 46. The door 22 has a cylindrical portion 54 with ends received in circular apertures of brackets 48 and 50. As such, cylindrical portion 54 of door 22 is retained in and pivoted on brackets 48 and 50. A flap portion 52 of door 22 is rigidly attached to the cylindrical portion 54 so that flap portion 52 is likewise pivoted with respect to the brackets 48 and 50 and hence end 16. Flap portion 52 acts to block passage of stain 14 out of vessel 12 through aperture 18.

A spring 24 is retained on cylindrical portion 54 and is in contact with the lower surface 40 of end 16 and is also in contact with a flap portion 52 of door 22. Spring 24 provides a biasing force to flap portion 52 to urge flap portion 52 against the lower surface 40 of end 16 to effect closure of aperture 18. Spring 24 can be provided with varying degrees of biasing force so that the door 22 can be tightly or loosely pressed against lower surface 40 to close aperture 18. If tightly pressed, door 22 acts to prevent stain 14 in vessel 12 from spilling even if vessel 12 is tipped over. If loosely pressed, stain 14 in vessel 12 may leak from vessel 12 although the leak may be slow enough that only a small amount of stain 14 will be lost if the vessel 12 is knocked over and then sat upright. Although a spring 24 with a strong amount of biasing force is desirable in that stain 14 will be retained in vessel 12, a stronger amount of force applied by the user to the microscope slide 20 is needed in order to overcome this biasing force and open door 22 for insertion. The spring 24 can be selected as needed depending upon the desired characteristics of cap 10. Once stain 14 is applied to specimen 72, the microscope slide 20 can be pulled from the vessel 12 and spring 24 acts to close door 22.

The cap 10 can be made of a variety of materials. For example, in accordance with one exemplary embodiment end 16, lip 42, slide guide 26 and door 22 are made of polypropylene. Other exemplary embodiments exist in which various components of cap 10 are made from steel, glass, plastic, rubber, aluminum, polyethylene, urethane or polyvinyl chloride.

Although shown as a pivoted connection, door 22 can be variously configured in other exemplary embodiments to effect opening and closing of aperture 18. For example, door 22 can be slid back and forth to cover and uncover aperture 18. Also, door 22 can be made of a resilient member in accordance with other exemplary embodiments. Here, microscope slide 20 can be urged against door 22 to deform door 22 and allow microscope slide 20 to be positioned into vessel 12. Once removed, door 22 can resume its natural shape which acts to form a seal to prevent spillage of stain 14 from vessel 12. In accordance with one exemplary embodiment, door 22 is a duckbill check valve.

The cap 10 allows for stain 14 to be applied to the specimen 72 on microscope slide 20 so that one does not have to unscrew the cap 10. As such, there is a less likely chance one will drop microscope slide 20 into stain 14, or will spill stain 14, or will leave the cap 10 off thus causing evaporation and loss of stain 14.

Another apparatus 66 useful in the preparation of a specimen 72 for study under a microscope is found in FIG. 5. Here, the apparatus 66 may be used to heat the specimen 72 on the microscope slide 20 in order to affix the specimen 72 thereon. Apparatus 66 includes a port 70 that receives the microscope slide 20. During use, the user inserts microscope slide 20 into port 70 and actuates apparatus 66 to heat the microscope slide 20 for a desired amount of time. After heating, the user may wait a brief amount of time to allow microscope slide 20 to cool so as not to burn his or her hands. Microscope slide 20 is then removed from port 70 for subsequent processing. Alternatively, microscope slide 20 can be removed immediately after heating. Exemplary embodiments exist in which a cool down mechanism, such as a fan, can be used in order to cool microscope slide 20 after heating.

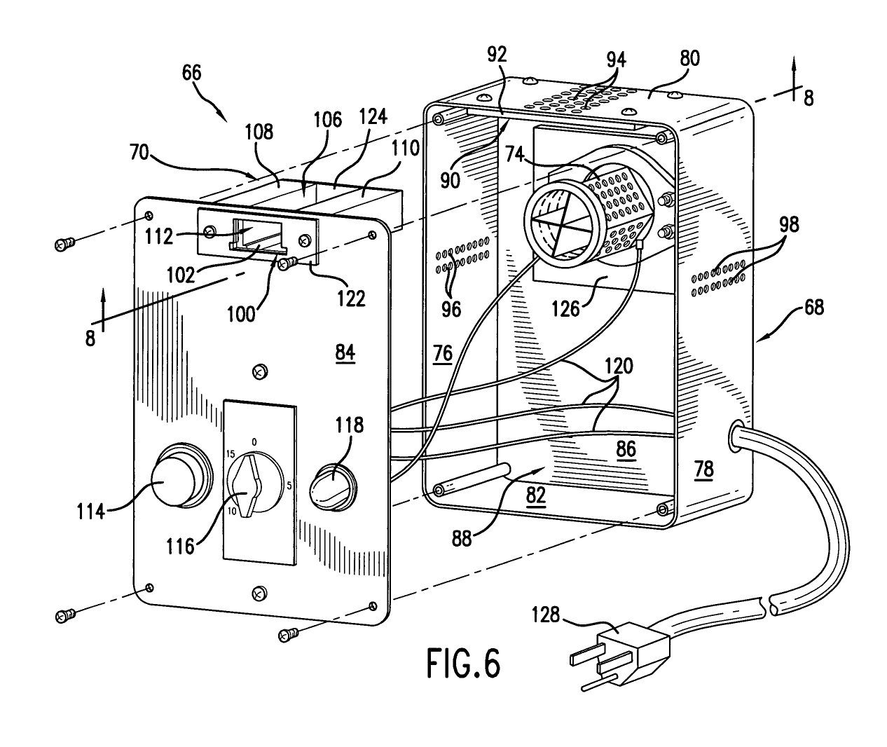

FIG. 6 shows the apparatus 66 of FIG. 5 disassembled. Apparatus 66 includes a frame 68 used to hold various components. Frame 68 shown has a series of walls that are arranged so as to define an interior 88. Frame 68 includes an upper wall 80 and an oppositely disposed lower wall 82. A front wall 84 is present and is opposite a back wall 86. A pair of side walls 76 and 78 are also included and are arranged in conjunction with walls 80, 82, 84 and 86 to define an interior 88 that is essentially enclosed. Although the frame 68 is shown as comprising a plurality of walls, it is to be understood that frame 68 can be arranged differently in other exemplary embodiments. For example, frame 68 can be made so as to have a structure that defines an essentially open interior 88. Further, frame 68 can be a base with a back wall with no front or side walls. Here, all of the components of apparatus 66 are mounted onto the back wall or to the base.

A heater 74 is included in apparatus 66 for purposes of supplying heat to the microscope slide 20. The heater 74 in the embodiment in FIG. 6 is an electrical heater that converts electrical energy to thermal energy. A plug 128 is plugged into a standard wall outlet in order to supply electrical energy to heater 74. Heater 74 is mounted onto a plate 126 which in turn is mounted onto the back wall 86 of frame 68. The mounting of these objects may be accomplished through the use of screws, adhesion, clips or other mechanical fasteners. Plate 126 may be made out of a ceramic or other non-thermally conducting material in order to prevent heat from heater 74 from being conducted into the back wall 86. Conduction of heat into back wall 86 may be problematic in that it is wasted as it will not act to heat the microscope slide 20. Further, a user may burn himself or herself by touching the heated portion of back wall 86.

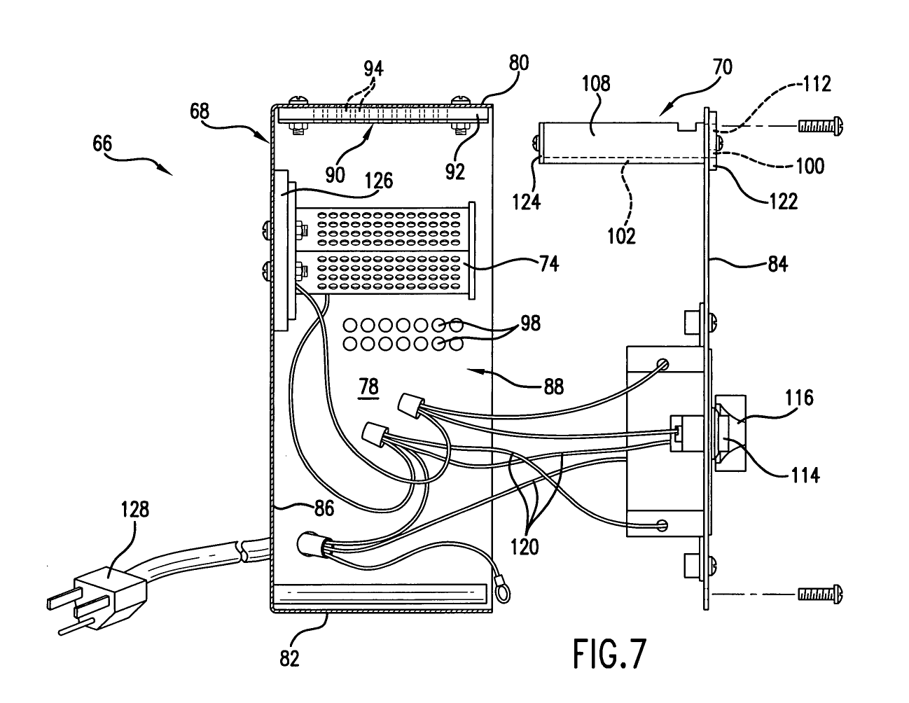

A port 70 is provided in order to receive the microscope slide 20 containing specimen 72. As shown, port 70 is located slightly above heater 74 so that heat emitted from heater 74 is transferred primarily by convection into the microscope slide 20 and specimen 72 held by port 70. Other arrangements of the apparatus 66 are possible in which heater 74 is configured to transfer heat primarily by conduction or by a combination of conduction and convection into the microscope slide 20 and specimen 72. With reference to both FIGS. 6 and 7, port 70 has a microscope slide aperture 100 that is sized large enough to allow the microscope slide 20 to be inserted therethrough and into the interior 88 of frame 68 to be heated. Port 70 also defines a finger aperture 112 to allow the user to insert his or her finger into port 70 in order to remove the microscope slide 20 once it is desirably heated. Apertures 100 and 112 are defined through a front plate 122 of port 70 and also through the front wall 84 of the frame 68. The portions of interior 88 of frame 68 in back of apertures 100 and 112 are empty space. In other embodiments, these areas may have objects located therein. The apertures 100 and 112 are integral with one another, but may be separated in other exemplary embodiments. Further embodiments exist in which the microscope slide aperture 100 exists but the finger aperture 112 does not exist.

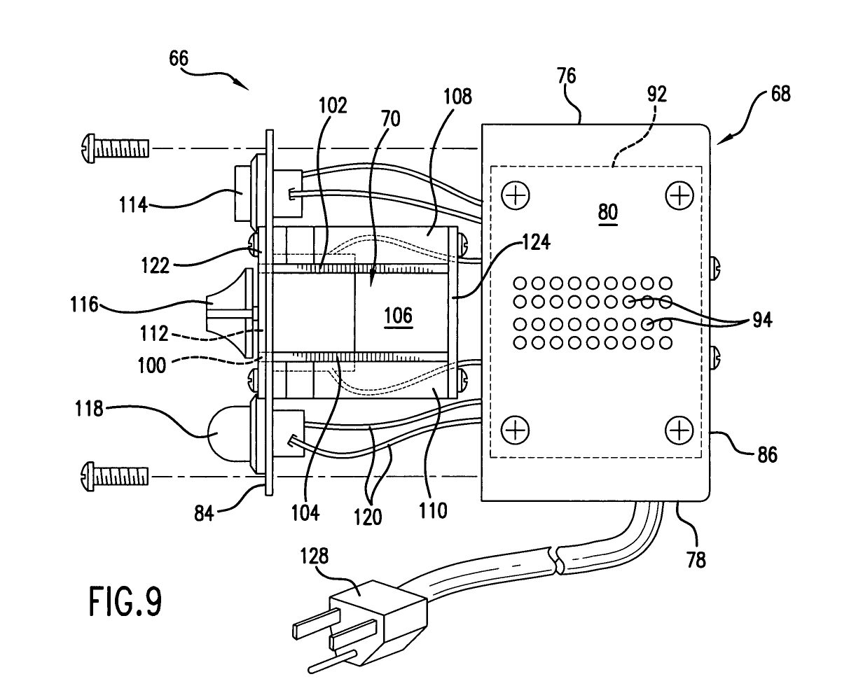

As can be seen more clearly with additional reference to FIG. 9, port 70 has a pair of ridges 102 and 104. These ridges 102 and 104 are separated by an opening 106 that resides directly above the heater 74. During heating, the microscope slide 20 is placed through the microscope slide aperture 100 and on top of ridges 102 and 104 to support microscope slide 20. The majority of microscope slide 20 is exposed to heater 74 through opening 106. The microscope slide 20 can be heated a desired amount and then removed from ridges 102 and 104 and out of port 70.

Port 70 also includes a pair of side members 108 and 110. In the exemplary embodiments shown, side members 108 and 110 are integrally formed with the ridges 102 and 104. In other embodiments, ridges 102 and 104 can be separate components that are attached to the side members 108 and 110. Side members 108 and 110 can be made of ceramic in order to inhibit thermal conduction therethrough. In this manner, conduction of heat from heater 74 will be limited in order to heat microscope slide 20 primarily through convection. In a similar manner the heat given off by the microscope slide 20 when heated will not be transferred by conduction out of the port 70 but instead will dissipate through convection upwards. The side members 108 and 110 thus act to channel a large percentage of heat from heater 74 into microscope slide 20. A back plate 124 is also present in port 70 and is connected to the ends of both side members 108 and 110. Back plate 124 can also be made of a material such as ceramic to prevent heat conduction into and out of port 70.

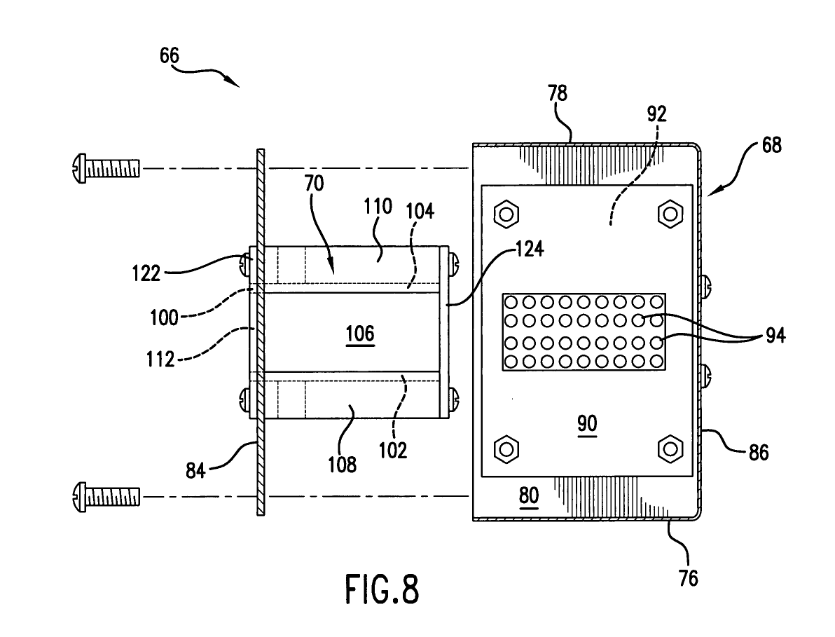

As more clearly shown with reference to FIGS. 7 and 8, the apparatus 66 also includes a shielding member 92 that has a heat reflective surface 90. Heat reflective surface 90 is located above port 70 and contacts the top of side members 108 and 110 when the apparatus is assembled. Heat reflective surface 90 acts to reflect heat back down into the interior 88 and prevents the upper wall 80 from overheating during use of heater 74. The shielding member 92 is a ceramic structure that has the heat reflective surface 90 attached onto its front face. The shielding member 92 acts to prevent heat from being transferred into the upper wall 80 so that the upper wall 80 does not become hot and burn a user that may touch the upper wall 80 during use. The shielding member 92 and heat reflective surface 90 are attached to the upper wall 80 through use of a plurality of screws. Other arrangements are possible in which these components are attached to the upper wall 80 though adhesion, hook and loop type fasteners or various types of mechanical fasteners. As shown in FIG. 8, heat reflective surface 90 has an aperture therethrough so as to expose the shielding member 92. A series of venting apertures 94 are defined through the shielding member 92 and the upper wall 80. The venting apertures 94 through upper wall 80 can be more clearly seen in FIGS. 5 and 6. With this arrangement, heat emitted from the microscope slide 20 is disseminated through apertures 94 and out of the apparatus 66. Desirably, this type of heat transfer prevents the upper wall 80 from overheating and causing injury to one that may contact the upper wall 80.

The side walls 76 and 78 of frame 68 also define a plurality of venting apertures 96 and 98 in order to transfer heat from the interior 88 of frame 68 to the environment. Additional components of apparatus 66 are shown with reference to FIGS. 5-7. An on/off button 114 is mounted onto the front wall 84 and is used to turning the heater 74 both on and off. During use of the apparatus 66, a user may insert plug 128 into an outlet and then press on/off button 114 so that electricity is transferred into heater 74 to generate heat for heating the microscope slide 20. One the microscope slide 20 is heated to a desired level, the on/off button 114 can be pressed again to shut off heater 74. A timer 116 is likewise incorporated into apparatus 66. A user can turn timer 116 to a set position to run for a desired amount of time. Once timer 116 runs for the set time, timer 116 turns off the heater 74. In this manner, microscope slides 20 can be heated for a certain amount of time depending upon the protocols of a particular procedure. An indicating lamp 118 is also mounted onto the front wall 84 and lights when the heater 74 is generating heat. Indicating lamp 118 is not lit when the heater 74 is not generating heat. Wires 120 are present for placing the various components into electrical communication with one another as needed.

The apparatus 66 can be configured in a variety of different manners in accordance with other exemplary embodiments. For example, a temperature probe can be used in order to sense the temperature at one or more locations. In one instance, the temperature of port 70 or of the microscope slide 20 can be sensed. In this embodiment, the heater 74 can be turned off once the microscope slide 20 and associated specimen 72 reach a predetermined temperature.

The present application also provides for a procedure for preparing a specimen 72 for examination by a microscope. First, a microscope slide 20 can be cleaned with soap and water in order to ensure no oil remains on the microscope slide 20 that could prevent the specimen 72 from being properly applied. Second, diluted water can be placed on the microscope slide 20 if the specimen 72 for examination is a solid. Next, the specimen 72 is placed onto the microscope slide 20. The specimen 72 may be optionally treated with diluted water if the specimen 72 is too viscous. In order to affix the specimen 72 to the microscope slide 20, the apparatus 66 is used to heat these two components.

The user can insert the microscope slide 20 with specimen 72 into port 70 of the apparatus 66. Next, the user can turn the timer 116 to a desired amount of time depending upon the particular specimen 72 for study. The timer 116 may be set for 5 minutes in accordance with one exemplary embodiment, but it is to be understood that the timer 116 can be set at various times in other procedures. For example, the timer 116 may be configured to be set from 1 minute to 25 minutes in accordance with certain exemplary embodiments. Once the timer 116 is set, the user depresses the on/off button 114 in order to begin heating of the microscope slide 20 and specimen 72 with the apparatus 66. Once the timer 116 counts off the selected amount of time, the timer 116 acts to shut off the heater 74 of the apparatus 66. The user has the option of also turning off the heater 74 at any point in time by pressing the on/off button 114.

Depending upon how much the microscope slide 20 and specimen 72 were heated, the user can either remove these components immediately from port 70 or wait for them to cool over some amount of time. The user can then transport the microscope slide 20 and specimen 72 to vessel 12 for application of stain 14 thereon. With reference to FIG. 1, three vessels 12, 58 and 62 are provided in order to store three different types of stain 14, 60 and 64. Various types of stains that can be employed include, but are not limited to, methylene blue, haematoxylin, eosin, silver staining, Nile blue, Nile red, and iodine. The user may insert the microscope slide 20 and specimen 72 through door 22 of cap 10 into vessel 12 so that the specimen 72 is coated with stain 14 from vessel 12. Next, the user may remove microscope slide 20 and specimen 72 from vessel 12 thus causing door 22 to close to prevent or inhibit stain 14 from escaping vessel 12 through spillage or evaporation. The user than then perform the same procedure in turn in order to stain specimen 72 with the second stain 60 held in the second vessel 58. In a similar manner, the same set of steps can be used to apply the third stain 64 of the third vessel 62 to specimen 72. In accordance with one exemplary embodiment of the present invention, a gram + or gram − test is conducted in order to determine the susceptibility of specimen 72, which is a bacteria, to antibodies. Here, the stain 14 is crystal violet, second stain 60 is iodine, and third stain 64 is safranin.

After the specimen 72 has been stained with one or more stains 14, 60 or 64, if needed excess stain can be rinsed off with diluted water and the specimen 72 can be blotted dry with a lint free towel. The microscope slide 20 and specimen 72 can then be placed onto a microscope and covered with a cover glass. The specimen 72 can then be examined by the user.

Although a procedure of preparing the specimen 72 in accordance with one exemplary embodiment of the present invention has been discussed, it is to be understood that other procedures are possible in accordance with alternative exemplary embodiments.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A cap for use with a vessel for storage of a stain, comprising:
an end defining an aperture therethrough, wherein said aperture is sized to allow at least a portion of a microscope slide to be positioned therethrough; and
a door capable of changing positions with respect to said end, wherein said door is capable of being positioned between a closed position to limit access through said aperture of said end and an open position to allow access through said aperture of said end.

2. The cap as set forth in claim 1, wherein said door pivots with respect to said end.

3. The cap as set forth in claim 1, further comprising a spring that engages said door, wherein said spring urges said door to said closed position.

4. The cap as set forth in claim 1, further comprising a slide guide attached to an upper surface of said end, wherein said slide guide has a pair of guide members positioned on opposite ends of said aperture of said end, wherein said guide members each define a slide groove for receiving a microscope slide, wherein said slide grooves extend at an angle to said upper surface of said end such that said slide grooves do not extend at a right angle to said upper surface of said end.

5. The cap as set forth in claim 1, wherein said end and said door are made of polypropylene.

6. The cap as set forth in claim 1, further comprising a lip extending from a lower surface of said end, wherein said lip has threading thereon configured for engagement with threading of the vessel used for the storage of stain.

7. The cap as set forth in claim 6, further comprising:
a pair of brackets extending from a lower surface of said end, wherein said door is pivotably mounted on said pair of brackets; and
a spring engaging said lower surface of said end and said door, said spring urging said door to said closed position.

8. An apparatus for use in heating a microscope slide, comprising:
a frame;
a port carried by said frame and configured for receiving a microscope slide; and
a heater carried by said frame, said heater configured for generating heat for use in heating a microscope slide when received by said port.

9. The apparatus as set forth in claim 8, wherein said frame has a plurality of walls that define an interior, and wherein said heater is located in said interior of said frame.

10. The apparatus as set forth in claim 9, further comprising a heat reflective surface located in said interior of said frame and configured for reflecting heat onto a microscope slide when received by said port.

11. The apparatus as set forth claim 10, further comprising a shielding member made of ceramic and carried by an upper wall of said frame, wherein said heat reflective surface is located on said shielding member, and wherein a plurality of venting apertures are defined through said upper wall of said frame and said shielding member for use in venting heat from said interior; and
wherein a pair of side walls of said walls of said frame define a plurality of venting apertures therethrough for use in venting heat from said interior.

12. The apparatus as set forth in claim 8, wherein said port defines a microscope slide aperture sized to allow a microscope slide to pass therethrough, and wherein said port has a pair of ridges with an opening defined therebetween, said ridges configured for receiving a microscope slide to hold the microscope slide during heating.

13. The apparatus as set forth in claim 12, wherein each one of said ridges of said port has a side member integral therewith, and wherein said port defines a finger aperture sized to allow a portion of the finger of the user to be inserted therethrough to aid in removal of a microscope slide from said port.

14. The apparatus as set forth in claim 8, wherein said port is made at least partially of a ceramic material to reduce conductive heat transfer through said port.

15. The apparatus as set forth in claim 8, further comprising:
an on/off button for use in turning on said heater and turning off said heater;
a timer for use in allowing said heater to remain on for a selected amount of time and then for turning off said heater after passage of the selected amount of time; and
an indicating lamp for use in indicating when said heater is on.

16. A method of preparing a specimen for examination with a microscope, comprising the steps of:
placing a specimen for examination onto a microscope slide;
positioning the specimen and the microscope slide so as to be received by a port of an apparatus that has an electric heater;
heating the specimen and the microscope slide with the electric heater of the apparatus so as to adhere the specimen to the microscope slide;
removing the specimen and the microscope slide from the port of the apparatus;
inserting at least a portion of the specimen and the microscope slide through a door of a vessel containing a stain into the interior of the vessel such that at least a portion of the specimen is stained by a stain contained in the vessel; and
removing the stained specimen and the microscope slide from the interior of the vessel.

17. The method as set forth in claim 16, wherein said inserting step involves moving at least a portion of the specimen and the microscope slide through a pair of slide grooves defined by a pair of guide members positioned on opposite ends of an aperture defined in an end of a cap of the vessel, and wherein the door of the vessel is spring loaded so as to be urged into the closed position, and wherein said inserting step involves urging the specimen and the microscope slide against the door so as to overcome the spring force of the door and push the specimen and the microscope slide into the interior of the vessel.

18. The method as set forth in claim 16, wherein said positioning step involves inserting at least a portion of the specimen and the microscope slide through a microscope slide aperture defined by the port and locating the specimen and the microscope slide onto a pair of ridges of the port that are separated by an opening therebetween.

19. The method as set forth in claim 16, wherein said heating step involves setting a timer to allow the heater to heat for a selected amount of time after which point the timer causes the heater to turn off.

20. The method as set forth in claim 16, further comprising the steps of:
inserting at least a portion of the specimen and the microscope slide through a door of a second vessel containing a second stain into the interior of the second vessel such that at least a portion of the specimen is stained by a second stain contained in the second vessel;
removing the stained specimen and the microscope slide from the interior of the second vessel;
inserting at least a portion of the specimen and the microscope slide through a door of a third vessel containing a third stain into the interior of the third vessel such that at least a portion of the specimen is stained by a third stain contained in the third vessel; and
removing the stained specimen and the microscope slide from the interior of the third vessel.
